(19) United States
(12) Patent Application Publication
(10) Pub. No.: US 2012/0102431 A1
(43) Pub. Date: Apr. 26, 2012

(54) DIGITAL MEDIA FRAME PROVIDING CUSTOMIZED CONTENT

(76) Inventors: Marc Krolczyk, Spencerport, NY (US); Jerald J. Muszak, Henrietta, NY (US); John T. Compton, LeRoy, NY (US); Kenneth A. Parulski, Rochester, NY (US)

(21) Appl. No.: 12/911,959

(22) Filed: Oct. 26, 2010

(51) Int. Cl. G06F 3/048

(52) U.S. Cl. 715/790

(57) ABSTRACT

A digital image display device for displaying a collection of digital media assets, comprising: a display screen; a processor; a real-time clock providing a date and time; an interface for accessing a collection of digital media assets stored on a processor-accessible asset memory, wherein at least some of the digital media assets are associated with one or more specified ranges of dates; and a processor-accessible program memory. The processor-accessible program memory stores executable instructions for causing the processor to execute the steps of determining a date from the real-time clock; identifying one or more digital media assets associated with a range of dates including the determined date; and preferentially displaying the identified one or more digital media assets on the display screen.

### FIELD OF THE INVENTION

This invention pertains to the field of digital media frames, and more particularly to digital media frames that automatically vary the content that is displayed throughout the calendar year.

### BACKGROUND OF THE INVENTION

A digital media frame (also called a digital photo frame or a digital picture frame) is a device that electronically stores and displays digital images. The digital images are typically captured using digital cameras, but may also be obtained using digital image sources such as scanners. For example, U.S. Pat. No. 4,754,271 to Edwards, entitled “Liquid Crystal Photograph,” describes a device resembling a pocket calculator which stores still pictures in a digital memory cartridge, and displays the pictures on a liquid crystal display (LCD) screen. The device includes an auto-sequencing mode which automatically changes the displayed image after a user-selectable time period, such as 5 seconds, or 5 minutes. However, once the user selects the mode, the same photos are viewed for the same period of time, in a repeating sequence, until the user changes the mode or adds new images to the digital memory cartridge.

Many digital media frames, such as the KODAK EASYSHARE D830 Digital Frame, include a real-time clock, which can be used to automatically turn on the device at a first programmable time (e.g. 10:00 AM each morning) and turn off the device at a second programmable time (e.g. 9:00 PM each evening). However, once the device is turned on, the same images are viewed using a predetermined viewing order. While some digital frames allow the images to be displayed in a random order, the same images are always displayed, albeit in a randomized order.

Digital media frames can include a modem to receive digital images over a communications network from computers or other devices, as described in commonly-assigned U.S. Pat. No. 7,155,679 to Bandaru et al., entitled “Digital media frame,” which is incorporated herein by reference. This patent further teaches that the digital media frame can include an information mode which displays news headlines, stock trading news, weather reports, and advertising received over the communications network. While new photos to be displayed may be added via the communications network, the other images stored in the digital media frame continue to be displayed in the same way, independent of the date or season.

FrameChannel is an Internet service that can be used with a digital media frame having a modem which enables an Internet connection, such as a WiFi modem, that enables communication with an Internet Service Provider (ISP) via a wireless home router. A FrameChannel customer can use a home computer to access the FrameChannel website (www.framechannel.com) in order to customize the context that will be provided to their digital media frame. The customer can select from many different channels of custom content including news, traffic, weather, sports, and financial data. While the user can select content categories of interest (e.g. weather for their location, the sports team they are most interested in), this content does not interact with their own photos. The display of the user's photos remains the same, independent of the date or season.

The Hallmark Corporation, Kansas City, Mo. offers a selection of so-called “Digital Scrapbooks” at their retail stores. This product is a USB flash drive which includes a software application program and content tailored for the particular product, such as for “graduation,” “baby,” and “holiday.” The software application enables the user to add photos, words, and music to the background slides that are included on the USB flash drive. This digital scrapbook plays on any digital frame or computer. However, the presentation of this scrapbook does not change in any way based on the date. The user must manually insert this USB flash drive into their frame, and then the frame will always display this exact scrapbook in the same way until the user removes it from the frame and manually updates the content.

In a paper titled “Travel Scrapbooks: Creating Rich Visual Travel Narratives” (Proc. IEEE International Conference on Multimedia and Expo, pp. 1314-1317, 2009), Setlur et al. describe an online service that automatically stitches information together from various online sources based on geo-tagged photos from social networks, and visually presents the information to the user in the form of a scrapbook metaphor. The system has three components, including (1) a data collection component which accesses photos and albums of people from the user's social networks, along with any associated metadata, (2) a data augmentation component that analyzes the data collected, identifies links between the data and content from on-line sources, and retrieves relevant online information from sources such as Wikipedia, event calendars, recommendations, ratings, books, and social networking data, and (3) a scrapbook rendering component for visualizing these information correlations in an interactive scrapbook form. While this interactive scrapbook can provide an informative and fun tool to enhance photo viewing, the level of interactivity required by the user is inappropriate for a digital media frame. Moreover, while the photo viewing experience can be manually changed by the user as they explore various pages in the interactive scrapbook, the experience does not change based on the day, date, or season when the user is viewing the interactive scrapbook.

As a result, digital frames continue to have a problem of “stale” content, where the same images are continually shown in the same way every day of the year, unless the user manually changes the images or adds new images. This can cause the user to become bored and disappointed with a digital frame viewing experience. What is needed is a way to automatically provide a more interesting and entertaining viewing experience.

### SUMMARY OF THE INVENTION

The present invention represents a digital image display device for displaying a collection of digital media assets, comprising:

a display screen;

a processor;

a real-time clock providing a date and time;

an interface for accessing a collection of digital media assets stored on a processor-accessible asset memory, wherein at least some of the digital media assets are associated with one or more specified ranges of dates; and
a processor-accessible program memory storing executable instructions for causing the processor to execute the steps of:
   determining a date from the real-time clock;
   identifying one or more digital media assets associated with a range of dates including the determined date; and
   preferentially displaying the identified one or more digital media assets on the display screen.

This invention has the advantage that the content displayed on the digital image display device is varied as a function of the date in order to keep the content from becoming stale.

It has the additional advantage that it preferentially displays images that are relevant to the current date so that the content is more interesting to viewers.

It has the further advantage that additional content such as backgrounds, overlays and text that is relevant to the current date is included together with the displayed images, thereby increasing the interest level to viewers.

### BRIEF DESCRIPTION OF THE DRAWINGS

FIG. 1 is a high-level diagram depicting the components of a digital image display device;

FIG. 2A and FIG. 2B depict the front and back of a digital image display device;

FIG. 3 is a high-level system diagram depicting how the digital image display device of FIG. 1 communicates with other devices to receive content and configuration information;

FIG. 4A is a high level flow diagram depicting a general image display process;

FIG. 4B is a high level flow diagram depicting a general system communications process;

FIG. 5 is a flow diagram showing a method for displaying customized content on a digital image display device according to an embodiment of the present invention;

FIG. 6A depicts a collection of digital images stored in the digital image display device;

FIG. 6B depicts digital images from the collection associated with a Halloween event;

FIG. 6C depicts digital images from the collection associated with a Matthew's Birthday event;

FIGS. 7A and 7B depicts animated graphics overlaying a first image, displayed during a Halloween event display date range;

FIGS. 7C and 7D depicts a background template and animated graphics overlaying a second image, displayed during a Matthew's Birthday event display date range; and

FIG. 8 depicts a decorative frame surround which can be attached to the digital media frame.

It is to be understood that the attached drawings are for purposes of illustrating the concepts of the invention and may not be to scale.

### DETAILED DESCRIPTION OF THE INVENTION

In the following description, some embodiments of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, a computer program for performing the method of the present invention can be stored in a non-transitory computer readable storage medium, which can include, for example; magnetic storage media such as a magnetic disk (e.g., a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program having instructions for controlling one or more computers to practice the method according to the present invention.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

Because digital media frames and related circuitry for providing digital interfaces, digital image storage, digital image processing, and image display are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

The following description of digital media frames will be familiar to one skilled in the art. It will be obvious that there are many variations of this embodiment that are possible and are selected to reduce the cost, add features or improve the performance of the digital media frame. The present invention is illustrated by way of example and not limitation in the accompanying figures.

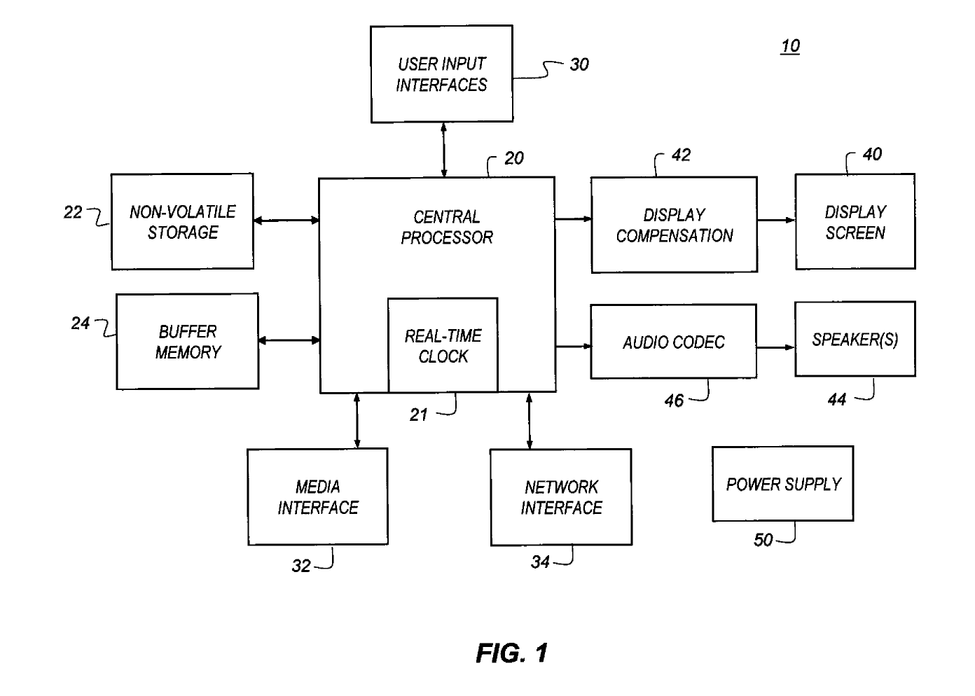

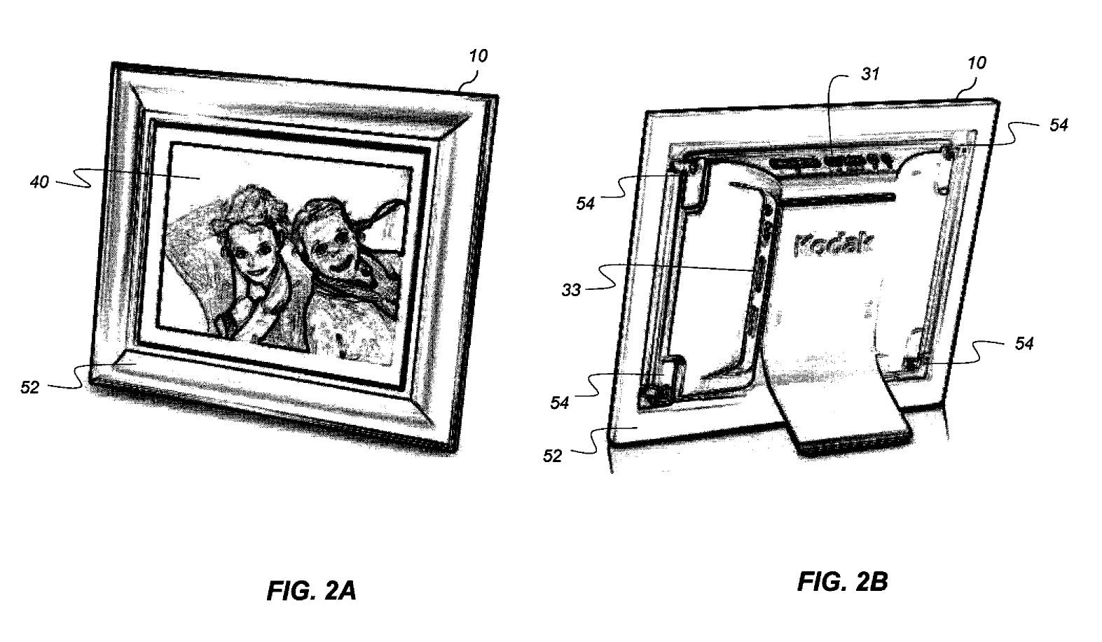

FIG. 1 is a high-level block diagram depicting an embodiment of a digital image display device 10. In a preferred embodiment, the digital image display device 10 is a digital media frame (i.e., a digital picture frame or a digital photo frame). However, in other embodiments, the digital image display device 10 can be any device having the ability to display digital media assets on a soft-copy display. Digital media assets would include both digital still images and digital video images. Examples of other types of digital image display devices 10 that can be used in accordance with the present invention would include tablet computers, personal computers, hand-held electronic devices (e.g., smart phones, PDAs or digital media players) and digital televisions. FIG. 2A depicts an embodiment of a front view of the digital image display device 10, and FIG. 2B depicts an embodiment of a rear view of the digital image display device 10. The digital image display device 10 includes a frame surround 52 which can be removed by moving the sliders 54 and replacing the frame surround 52 with a different frame surround, which may have a different color, finish, etc.

The digital image display device 10 allows a user to display digital media assets with minimal user intervention. The digital media assets to be displayed typically includes digital still images captured with a digital camera. The digital media assets to be displayed can also include video clips, graphic images, text, and animations. The digital media assets can also include audio information, which can include music, speech, and sound effects.

Referring to FIG. 1, a central processor 20 in the digital image display device 10 provides the overall control of the digital image display device 10. The central processor 20 is coupled to a user input interfaces block 30, which enables a user of the digital image display device 10 to select operating modes and images to be displayed. The central processor 20 is also coupled to a media interface block 32, and a network interface block 34, which are used to provide digital media assets to the digital image display device 10. The central processor 20 is also coupled to a non-volatile storage block 22 via an interface, which provides a processor-accessible program memory that stores executable instructions that are used to control the operation of the central processor 20. Non-volatile storage block 22 can also serve as a processor-accessible image memory for storing a collection of digital media assets.

The central processor 20 is also coupled to a buffer memory block 24, which temporarily stores digital media assets for display on display screen 40. The central processor 20 is also coupled to a display compensation block 42, which processes the digital images and provides the compensated digital images to the display screen 40. The central processor 20 is also coupled to an audio codec block 46, which processes digital audio information and converts the digital audio information to one or more analog signals, which are provided to one or more speakers 44.

The user input interface block 30 can be provided using various conventional user input devices and circuits. For example, the user input interface block 30 can include a group of user buttons 31, such as those provided on the upper back of the digital image display device 10 in FIG. 2B. These user buttons 31 can include, for example, a forward function button, a reverse function button, and a pause function button. The forward function button allows the user to initiate the display of the next image in a playlist, the reverse function button allows the user to initiate the display of the previous image in a playlist, and the pause function button allows the user to initiate the continued display of the current image, until a different function button is pressed by the user. The user buttons 31 can also include a “menu” button, a “select” button” and a number of cursor movement buttons, such as “up,” “down,” “left” and “right,” or some subset thereof. These can be used to select various operating modes.

In some embodiments, the user input interface block 30 includes a touch screen interface provided on the front surface of the image display 40. In some embodiments, the touch screen interface can be implemented using IR emitters and detectors in front of, and parallel to, the display screen 40. A “touch” is detected by determining which IR beams have been blocked by the viewer's finger. In some embodiments, this can be implemented using a relatively small number of emitters and detectors. For example, using 5 emitters spaced vertically and 8 detectors spaced horizontally, enables the detection of 5×8 positions on the display screen. This is enough to allow touch buttons icons to be displayed on the display screen 40 and discern which button icon was touched by the viewer.

In some embodiments, the user input interface block 30 includes a touch sensitive input surface that can be positioned adjacent to the display screen 40. For example, the KODAK EASYSHARE P730 Digital Frame includes two “Quick Touch Border” capacitive touch strips, including a horizontally oriented touch strip adjacent the bottom of the display screen 40 and a vertically oriented touch strip adjacent the right side of the display screen 40. Menu items are displayed on the display screen 40 adjacent to these touch strips, and the viewer touches the strip at the appropriate location in order to select menu items. One advantage of the Quick Touch Border is that it keeps fingerprints off of the display screen 40.

In some embodiments, the user input interface can also include a remote control input device. The remote control can include user inputs which replicate some or all of the functions provided by the user buttons 31. In some embodiments, the user input interface can also include a sound activated input device (including a microphone and speech recognition processor) or a sensing device (such as a camera) which recognizes user hand gestures or other user movements.

Non-volatile storage block 22 represents non-volatile storage memory, which may include, for example, flash EPROM memory. Non-volatile storage block 22 provides a processor-accessible program memory for storing executable instructions, such as firmware programs, for controlling the operation of the central processor 20.

In some embodiments, the firmware programs stored in non-volatile memory block 22 can be updated or replaced by new firmware provided using the media interface block 32 or the network interface block 34. In some embodiments, other types of non-volatile memory, such as Read Only Memory (ROM), magnetic disk storage or optical disc storage, can be used. In some embodiments, the central processor 20 includes an additional program memory (not shown), and the firmware programs stored in the non-volatile storage block 22 are copied into the program memory before being executed by the central processor 20.

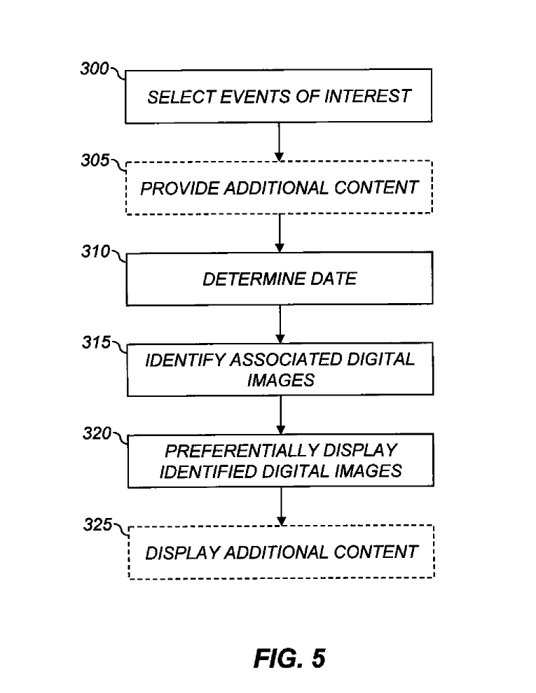

The non-volatile storage block 22 can also be used to provide a processor-accessible image memory for storing a collection of digital media assets such as still images, video clips, sounds music, graphics, text, and other types of content which can be used to create the images displayed on the display screen 40 and the sounds output from speaker(s) 44. These sounds can include sounds captured by the digital still or video camera when the digital images were captured. These sounds can also include sounds (such as audio annotations) captured when the images were previously viewed, either by the user or another individual. These sounds can also include songs or music soundtracks that have been associated with the digital images. As will be described later in reference to FIG. 5, at least some of the stored digital media assets are associated with particular events either automatically as a result of the image capture date, or as a result of manual selection by the user. The sounds can also include audio content associated with the particular events.

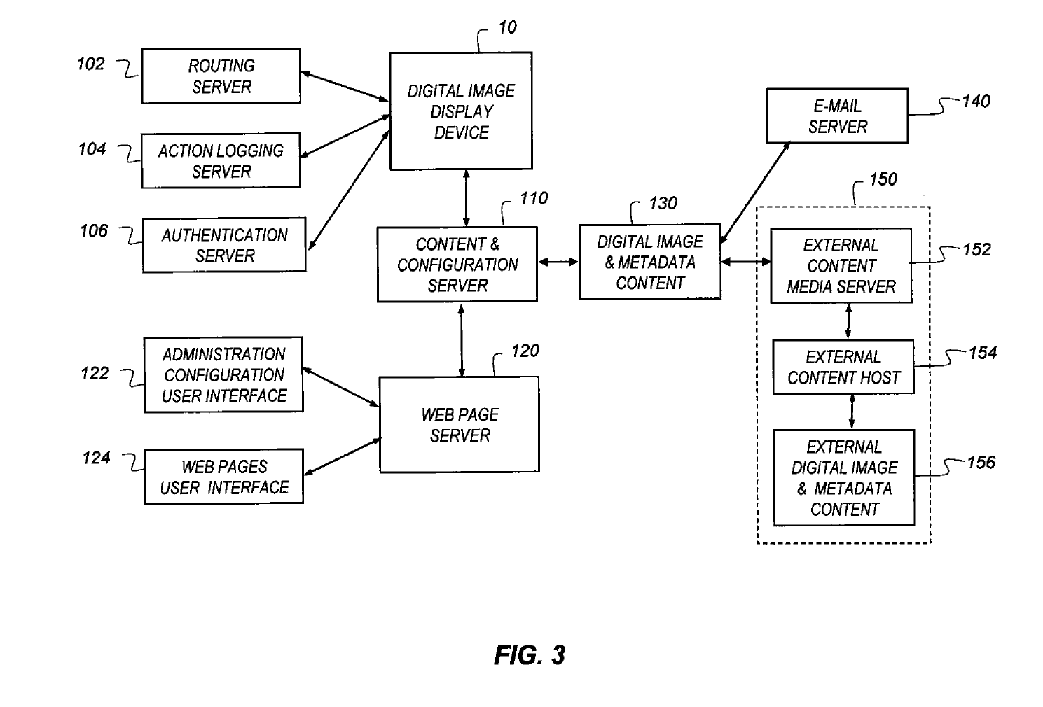

The non-volatile storage block 22 also stores auxiliary information (e.g. metadata) associated with the digital media assets. This metadata can include the date and time the image was captured by a digital capture device (e.g., a digital still camera or a digital video camera), or the date and time the image was received by the digital image display device 10. The metadata can also include data which identifies the individual or service that provided the digital media assets that was transferred to the digital image display device 10 using the system to be described later in reference to FIG. 3.

Buffer memory block 24 is a relatively small memory (compared to non-volatile storage block 22) which provides fast memory access for displaying images. The buffer memory block 24 can use, for example, one or more dynamic random access memory (“DRAM”) or static random access memory (“SRAM”) integrated circuits.

The media interface block 32 receives digital media files from various local external devices, such as removable media devices. For example, the media interface block 32 can include memory card and USB interface connectors 33 (FIG. 2B), to enable the digital image display device 10 to display media files stored on various removable Flash memory cards, such as a Secure Digital (SD) card, a micro SD card, a Compact Flash (CF) card, a MultiMedia Card (MMC), an xD card or a Memory Stick, as well as USB memory “sticks” or “jump drives”. The digital media assets stored on these memory devices can be provided by digital computers, digital still cameras, digital video cameras, camera phones, PDAs, print and film scanners, and other types of digital imaging devices. The central processor 20 controls the media interface block 32 in order to transfer media files from the local external devices. The transferred files can be stored in the non-volatile storage block 22, or can be stored directly in the buffer memory block 24 for immediate display on the display screen 40. Thus, the media interface block 32, in combination with the removable memory card or memory “stick”, provides a processor-accessible image memory for storing a collection of digital media assets, such as digital images.

The network interface block 34 can be used to enable other devices, such as computers or mobile imaging devices, to transfer digital media files to the digital image display device 10. The network interface block 34 can be provided using a wired interface, such as an Ethernet cable interface or a wired telephone modem. The network interface block 34 can also be provided using a wireless interface, such as a WiFi (e.g. IEEE 802.11 WiFi standard) modem, a cellular modem, or a Bluetooth modem.

In some embodiments, the network interface block 34 provides a direct connection to the Internet, and is configured to read HTML (“HyperText Markup Language”) and to use TCP/IP (“Transmission Control Protocol/Internet Protocol”). In other embodiments, the network interface block 34 provides a connection to a local area network, which can then provide an Internet connection using a wired or wireless router or other type of network interface device, which either interfaces directly to the Internet, or to an Internet Service Provider (ISP).

The display compensation block 42 is used to adjust the image data for the characteristics of the display screen 40. This can include tone scale adjustments, color adjustments, sharpness adjustments or any other type of appropriate adjustment. It should be noted that in some embodiments, the display compensation block 42 can be implemented by the central processor 20. In other embodiments, the display compensation block 42 and central processor 20 can be integrated into the same integrated circuit (“IC”).

The display screen 40 displays images using a soft-copy display device, such as a color active matrix LCD (“Liquid Crystal Display”). Other types of soft-copy display devices may be used, such as an OLED (“Organic Light Emitting Diode”) display, a CRT (“Cathode Ray Tube”), or various silicon-based displays.

A power supply 50 converts the AC power supplied via a wall plug to the proper DC voltages needed to provide power to all of the components of the digital image display device 10. In some embodiments, the power supply can include a re-chargeable battery, so that the digital image display device 10 can be portable, thus allowing it to be used for a period of time without a power cable, and outdoors. In some embodiments, the digital image display device 10 can include a solar panel which is used to charge the rechargeable battery.

In some embodiments, the digital image display device 10 includes a motion sensor (not shown). The motion sensor can provide a signal to the central processor 20, which controls the power supply 50 in order to supply power to the display screen 40 only when motion is detected. This reduces the power wasted when displaying images if there are no viewers in the vicinity of the digital image display device 10.

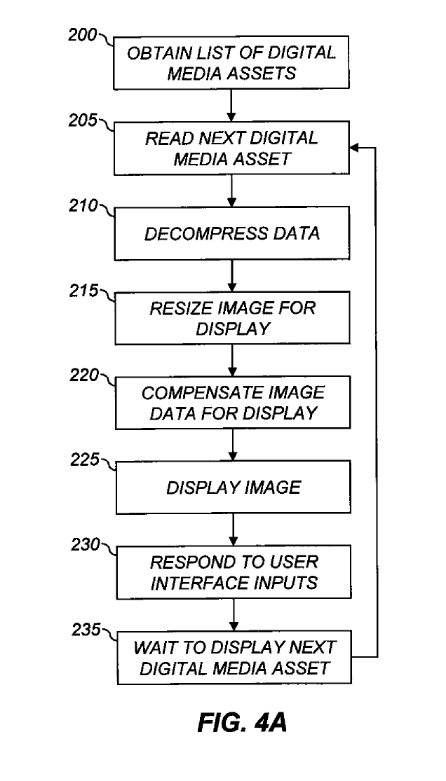

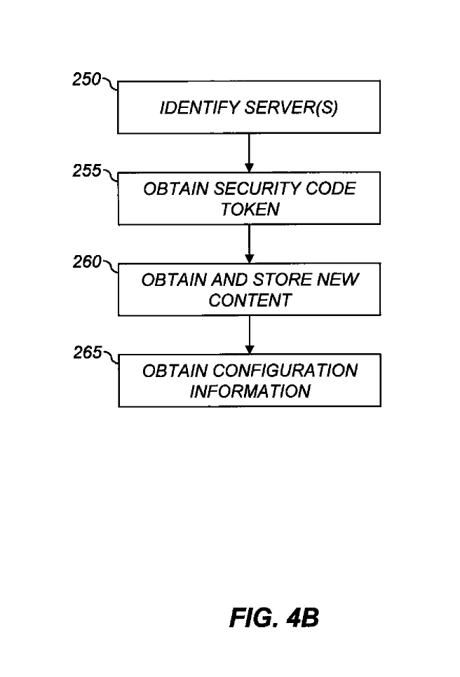

The central processor 20 runs two primary processes in order to display images and communicate with other system components, as will be described later in reference to FIG. 4A and FIG. 4B. A real-time clock 21 in the central processor 20 provides a date/time value, as will be described later in reference to FIG. 5. In some embodiments, the real-time clock 21 is not located within the digital image display device 10, but rather is accessed on an external device using the network interface block 34.

It will be understood that the functions of the central processor 20 can be provided using a single programmable processor or by using multiple programmable processors, including one or more digital signal processor (DSP) devices. Alternatively, the central processor 20 can be provided by custom circuitry (e.g., by one or more custom integrated circuits (ICs) designed specifically for use in digital media frames), or by a combination of programmable processor(s) and custom circuits. It will be understood that connections between the central processor 20 and some of the blocks shown in FIG. 1 can be made using a common data bus. For example, in some embodiments the connection between the central processor 20, the non-volatile storage block 22, the buffer memory block 24, the media interface block 32, and the network interface block 34 can be made using a common data bus.

FIG. 3 is a high-level system diagram depicting an embodiment of how the digital image display device 10 can communicate over a network with other systems to receive content and configuration information. It will be understood that a large number of digital image display device 10 units, located at many different geographically dispersed locations, can be supported by the system depicted in FIG. 3. The digital image display device 10 communicates over a network (such as the Internet) with a routing server 102, an action logging server 104, and an authentication server 106. The digital image display device 10 also communicates over the network with content and configuration server 110. The content and configuration server 110 communicates with a web page server 120. The web page server 120 can be controlled by an administration configuration user interface 122 and a web pages user interface 124. The content and configuration server 110 can obtain digital image and metadata content 130 from an E-mail server 140 or from one or more content providing systems 150. A plurality of content providing systems 150 can provide content from a plurality of sources, such as Facebook, Flicker, the Kodak Gallery, and other on-line content storage systems and services.

Each content providing system 150 can include an external content media server 152 which communicates with an external content host 154 in order to supply external digital image and metadata content 156. The external digital image and metadata content 156 can be stored on hard drives or other digital storage devices or media that can be accessed by the external content host 154.

It will be understood that the various blocks shown in FIG. 3 can be implemented using different hardware configurations. For example, the routing server 102, action logging server 104 and authentication server 106 can execute on the same physical hardware, or on different hardware. Furthermore, each server, such as routing server 102, may execute on multiple pieces of hardware in order to execute operations in parallel.

FIG. 4A is a high level flow diagram depicting a general image display process performed by the central processor 20 as a foreground process. In obtain list of digital media assets step 200, the central processor 20 gets a list of digital media assets to be displayed from the non-volatile storage block 22 or from some other digital media asset storage location (e.g., storage media connected via the media interface block 32, or a remote storage location accessible via the network interface block 34). A digital media asset is a discrete piece of digital media content such as a digital still image, a digital video clip, a digital audio clip or music file, graphics, text, and other types of content that can be used to create the images displayed on the display screen 40 and the sounds output from speaker(s) 44 of the digital image display device 10. A collection of digital media assets is the set of all the digital media assets that are available for display or playback on the digital image display device 10. A list of digital media assets is a list of the individual digital media assets in the collection of digital media assets. This list can be stored as a formatted text file (e.g. an XML file), or as a database. The list can be provided in the display order in which content is to be displayed, or the display order can be specified as a separate field. In some operating modes of the digital image display device 10, the content is intentionally displayed in a randomized order.

In read next digital media asset step 205, the central processor 20 reads the list and determines the next digital media asset to display from the list. The central processor 20 then reads the digital media asset from the non-volatile storage block 22 or the storage media connected to media interface block 32. In some embodiments, the central processor 20 can read the digital media asset from a remote storage site via the network interface block 34.

In decompress data step 210, the central processor 20 decompresses the image data associated with the digital media asset and stores the decompressed image data in the buffer memory block 24. If the digital media asset is a video file, such as an MPEG 2 or MPEG 4 video file, the central processor 20 performs real-time decompression of the compressed video file.

In resize image for display step 215, the central processor 20 scales the image for display, by resizing the image as necessary in order to match the image size (i.e., the screen resolution) required by display screen 40. In some embodiments, the image size stored in buffer memory block 24 is slightly larger than the screen resolution, in order to allow for some panning/zooming effects as the image is displayed.

In compensate image data for display step 220, the display compensation block 42 applies compensation to the image data before it is provided to the display screen 40. The compensation typically includes adjusting the image to account for the characteristics of the display screen 40 (e.g., an LCD panel). In some embodiments, the compensation may also adapt to the content of the specific image, for example, to provide image-specific enhancements.

In display image step 225, the central processor 20 displays the current image on the display screen 40. The central processor 20 can also display visual messages or user interface controls on the display screen 40, to indicate to the user of the digital image display device 10 various operating modes and options that can be selected by the user. In some embodiments, the central processor 20 provides these messages and controls using an on-screen graphics buffer, which can be stored in a portion of buffer memory block 24. The graphics information provided from this on-screen graphics buffer can be blended with the currently displayed image when the user activates one of the user interface elements of the user input interfaces block 30, such as a touch screen interface. In some embodiments, the text and icons are transparently overlaid on top of the currently displayed image.

In respond to user interface inputs step 230, if the user makes a selection using one of the user input elements, the central processor 20 takes one or more actions in response to the user selection. This can include, for example, changing the display time for images, deleting an image from the collection of digital media assets, or selecting a subset of the collection of digital media assets to display.

In wait to display next digital media asset step 235, the central processor waits until the real-time clock 21 has advanced by a specified time interval between images, and then execution returns to the read next digital media asset step 205. The specified time interval can be a factory default time interval (e.g., 10 seconds per image) or can be a time interval selected by the user. The central processor 20 also controls the type of transition between images. The transition is a mechanism of “retiring” the current image while “phasing in” the next image. For example, one type of image transition moves the current and next images in one direction (e.g. left to right, or top to bottom) such that the current image moves out while the next image moves in. In another example, the image transition fades out the current image while fading in the next image on top of the current image.

FIG. 4B is a high level flow diagram depicting a general system communications process, which is performed by the central processor 20 via the network interface block 34 as a background process. In some embodiments, the network interface block 34 is a WiFi wireless interface, which enables the digital image display device 10 to wirelessly communicate with various servers such as routing server 102, action logging server 104, authentication server 106 and content and configuration server 110 over a network, such as the Internet.

At startup, an identify server(s) step 250 is performed, during which the digital image display device 10 interfaces via network interface block 34 over the Internet to the routing server 102 at a known server location, in order to identify itself and determine how to proceed. The routing server 102 returns information to the digital image display device 10 that indicates which server(s) the digital image display device 10 should communicate with for all subsequent functions. The only address that is not allowed to change is the path to this routing server 102.

In obtain security code token step 255, the digital image display device 10 queries the authentication server 106 for a security code to communicate with the rest of the system. The authentication server 106 generates a temporary security token and returns the token to the digital image display device 10. The token is made available to other parts of the server (and other servers) to allow authentication of the particular digital image display device 10 for future operations.

When the time window for the authentication token expires, any operations from the digital image display device 10 to one of the servers (other than the authentication server 106) will be rejected. In this situation, the digital image display device 10 then communicates with the authentication server 106 in order to acquire a new authentication token, before continuing with other operations.

In obtain and store new content step 260, the digital image display device 10 communicates with the content and configuration server 110 in order to retrieve any new content that may be available. The digital image and metadata content provided by the content and configuration server 110 is organized into groups of pictures that are grouped by some combination of the source of the content (e.g., E-mail versus Facebook), a unique identifier of the sender of that content (e.g., the E-mail address of the sender who provided the content), and the date and time that the particular content was shared (or the instance of sharing).

The digital image and metadata content 130 is obtained through a separate interface to content and configuration server 110, and is stored using an appropriate non-volatile storage (not shown) available to the content and configuration server 110. The content and configuration server 110 sends a description of the new content to be stored on the digital image display device 10. The central processor 20 in the digital image display device 10 then individually retrieves each of the digital media assets defined by the content and configuration server 110 and stores each digital media asset in the non-volatile storage block 22 in the digital image display device 10. The digital image display device 10 also transfers metadata related to each digital media asset, such as the source of the image (e.g., Facebook, Kodak Gallery), the sender and sharing instance, and any descriptive text available related to the digital media asset. In some embodiments the digital media assets are only downloaded from the content and configuration server 110 at the time when they are to be displayed on the digital image display device 10, and are not stored locally in the non-volatile storage block 22 in the digital image display device 10.

The user can add content to the digital image display device 10 by using the web pages user interface block 124 to upload digital images and other digital media assets to the web page server 120. The web page server 120 then stores these digital media assets and appropriate metadata as digital image and metadata content 130.

In obtain configuration information step 265, the digital image display device 10 communicates with the content and configuration server 110 in order to retrieve configuration information. The configuration information includes settings such as the type of slideshow transition, the time interval for displaying each slideshow image, and the time of day to automatically turn the digital image display device 10 on and off.

In some embodiments, factory default configuration information is stored on the content and configuration server 110 automatically when a digital image display device 10 is registered. The user can utilize the web pages user interface block 124 to modify the configuration information. Additionally, configuration information can be modified by a system administrator using the administrator configuration user interface 122, in order to address any service related issues or to provide updates.

The user can use the web pages user interface block 124 to permit E-mail transfer of digital media assets to their particular digital image display device 10. In this case, the user enters a specific E-mail address to enable content to be sent to their digital image display device 10. When E-mail is sent (typically by others) to that address on the E-mail server 140, the digital images and other relevant content is extracted from the E-mail and transferred to the digital image and metadata content 130. Metadata about the sender, sharing date, etc. is also stored in association with this content.

The user can also use the web pages user interface block 124 to configure their digital image display device 10 to receive digital media assets that are provided from one or more content providing systems 150 through various external services on the Internet. There are two mechanisms for how content is transferred from the external content providing systems 150, depending on how the external system operates.

In a first “pull” mechanism, the content and configuration server 110 periodically polls the external content media server 152 to determine whether new external digital image and metadata content 156 is available from external content host 154. If new content is available, the content and configuration server 110 retrieves the metadata for the new content and stores it in the digital image and metadata content 130. The original digital media asset data (e.g., still digital image or digital video file) is not transferred. When the digital image display device 10 later retrieves the list of digital media assets to retrieve, the URL for this new digital media asset will point back to the corresponding external content media server 152.

In a second “push” mechanism, the external content media server 152 provides a notification when new external digital image and metadata content 156 is available from external content host 154. In this case, the content and configuration server 110 configures the external content media server 152 to provide a notification whenever relevant additions or changes are made for the content requested. The external content media server 152 then notifies the content and configuration server 110 when content is added, modified or removed. The content and configuration server 110 then updates the digital image and metadata content 130 to reflect the new state of the external content providing systems 150. It will be understood that the content and configuration server 110 stores configuration information for a large number of digital image display device 10 units, and that each digital image display device 10 can be configured to permit content to be provided from a number of different external content providing systems 150 (such as Facebook, Flicker, etc.) using “pull” or “push” mechanisms. The obtain and store new content step 260 and the obtain configuration information step 265 are repeated at regular intervals (e.g., every ten minutes) in order to obtain new content for digital image display device 10.

In some embodiments, the digital image display device 10 has an “informational” mode as well as a “pictorial digital media asset” mode. The informational mode of digital image display device 10 displays a set of information, such as news headlines, financial data, advertising, and the like. The information can be displayed instead of, or along with, the pictorial digital media assets. In the latter case, the digital image display device 10 dedicates a portion of the display screen 40 to pictorial display while another portion of the screen is apportioned to informational display. The informational display can be located adjacent to the pictorial display, or can be overlaid on top of the pictorial display. The information to be displayed can be provided using the system depicted in FIG. 3. The types of information to be provided can be configured for a particular user of digital image display device 10 by using the web pages user interface block 124 to select the particular information of interest to the user. This can include information about particular stocks, sport teams, weather reports, news categories, shopping, gambling, etc., which are of interest to the user. In some embodiments, the information can be provided by various information content web servers (not shown) which provide content to the content and configuration server 110. In other embodiments, the digital image display device 10 can communicate directly with the external web sites (not shown) that provide the information, in order to receive and display web pages, using a web browser implemented in the digital image display device 10.

FIG. 5 is a flow diagram showing a method for providing customized content on a digital image display device 10 in accordance with one embodiment of the present invention. It will be understood that in some embodiments the digital image display device 10 can include at least one operating mode that provides customized content, and another mode that operates in a standard fashion. The user can select between these operating modes, for example, by using user input interfaces block 30 or using the web pages user interface block 124.

In select events of interest step 300, the user selects events of interest (e.g., birthdays, holidays) during which it is common for the user to capture digital still or video images. This selection can be done, for example, using the web pages user interface block 124 in FIG. 3. The user can select “standard” events from a list such as holidays, and can also enter names and dates of family-specific events such as birthdays and anniversaries. Some examples of events of interest are shown in Table 1.

TABLE 1
Example events of interest

| | | Display Date | Capture Date |
|---|---|---|---|
| Event | Event Date | Range | Range |
| New Years Day | Jan 1 | Dec 30-Jan 5 | Dec 31-Jan 1 |
| Winter Period | Varies | Jan 10-Jan 30 | Jan 10-Jan 30 |
| Valentine's Day | Feb 14 | Feb 14-16 | Feb 14 |
| President's Week | Varies | Feb 15-30 | Feb 15-30 |
| Wedding Anniversary | Apr. 4, 1987 | Apr 4 | Apr 4-6 |
| Easter | Varies | Date +/−1 week | Specific Date |
| Ken's Birthday | May 7 | May 5-9 | May 7 |
| Independence Day | July 4 | Jul 4 | July 4 |
| Summer Vacation | Varies | Jul 10-Aug 30 | Jul 10-Aug 30 |
| Susan's Birthday | Sep 23 | Sep 21-25 | Sep 23 |
| Halloween | Oct 31 | Oct 15-Nov 5 | Oct 24-31 |
| Thanksgiving | Varies | Date +/−1 week | Specific Date |
| Matthew's Birthday | Dec. 5, 1996 | Dec 2-7 | Dec 5-6 |
| Christmas | Dec 25 | Dec 15-29 | Dec 20-26 |

Table 1 includes an actual date for each event, a “display date range”, which is the period of time that the digital image display device 10 will be customized to preferentially display content for this particular event, and a “capture date range” which is the range of capture dates of photos to be preferentially displayed during the display date range period. In some cases, the date of the event (such as Easter or Thanksgiving) changes from year to year. In this case, the actual date for the event, in a particular year, can be determined from a calendar database, or an algorithm. Note that there is no requirement that the dates associated with a particular even are contiguous. For example, a Golf Night event could be defined corresponding to a weekly golf league. The Golf Night event display date range could be defined to be the days of the weekly golf league (e.g., Tuesdays in June-August). The Golf Night event capture date range could be defined to select images captured during the time of the golf league (e.g., 6:00 PM-8:00 PM for Tuesdays in June-August).

In some embodiments, the user can manually select particular images which were captured on dates outside the capture date range, and associate them with a particular event for preferential display. In some embodiments, if a large number of images have a capture date range associated with a particular event, the number of images can be reduced either randomly, or by using affective metadata associated with the images. The affective metadata can be generated and used as described in commonly assigned U.S. Pat. No. 7,307,636 to Matrazek et al., entitled “Image format including affective information,” the disclosure of which is herein incorporated by reference.

In some embodiments, at least some of the events of interest to the user can automatically be determined from a calendar application running on a computer resource accessible to the digital image display device 10. For example, the calendar application can be running on a personal computer, a PDA or a calendaring website. Calendar entries can be examined to look for keywords such as birthday or anniversary to identify events of interest. The user can be presented with the identified events to provide the user with the opportunity to confirm that they are appropriate events of interest.

In some embodiments, at least some of the events of interest to the user can be automatically determined by analyzing one or more social network web sites associated with the user, such as their personal MySpace or Facebook page. The information that can be obtained from social networking websites can include the names and birth dates of family members, as well as important anniversaries and historical events of interest to the user. In some cases, the information provided on a social networking website can be used to automatically provide additional content which is customized for the particular user. This can include, for example, the user's alma mater, favorite music genres and singers and their favorite sports teams and athletes. This information can be used to provide additional content or additional events which are likely to be of interest to the user.

In an optional provide additional content step 305, the user can select, or approve, additional content which is relevant to the events selected by the user in the select events of interest step 300, and which can be provided by content and configuration server 110. The additional content can include background templates, overlay animations, and sound effects. This content is associated with particular events, such as the events listed in Table 1. For example, one or more backgrounds having a Halloween theme can be used when displaying images captured during the Halloween event capture date range (e.g., October 24-31 of previous calendar years) during the Halloween event display date range, (e.g., October 15 through November 5 of each calendar year). In addition, the content can include static or dynamic image overlays, such as animated spiders that “crawl over” the user's photos. The content can also include sounds associated with the period of interest, such as scary organ music, screaming voices, etc. In some embodiments, the additional content can be provided automatically for standard event types, so that the provide additional content step 305 is performed automatically such that user does not need to select specific content or perform any actions.

As another example, on a date corresponding to a family member's birthday, the frame can display additional content which includes a birthday wrapping paper background, animated birthday balloons floating above the user's photos taken on that date during previous calendar years, while “Happy Birthday to You” music is played. In some embodiments, the additional content can be customized for a particular instance of an event, such as a 25^{th} wedding anniversary.

The additional content and date ranges are then transferred from the content and configuration server 110 to the digital image display device 10. In some embodiments, after the user makes the selections described with reference to the select events of interest step 300 and the provide additional content step 305, all of the additional content is transferred to the digital image display device 10 and stored in non-volatile storage block 22. In other embodiments, only a portion of the additional content is transferred from the content and configuration server 110 to the digital image display device 10. This portion may include only the additional content needed for one, or the next few, upcoming event periods.

In determine date step 310, the central processor 20 determines the date from the real-time clock 21. The central processor then determines if the current day of the year falls within any of the display date range for any of the events listed in Table 1. For some events, such as birthdays and anniversaries, the current year can also be used to calculate a wedding anniversary year or birthday age. This can be used to provide customized content, for example a graphic including the text “Happy 14th Birthday”, as will be described later in reference to display additional content step 325.

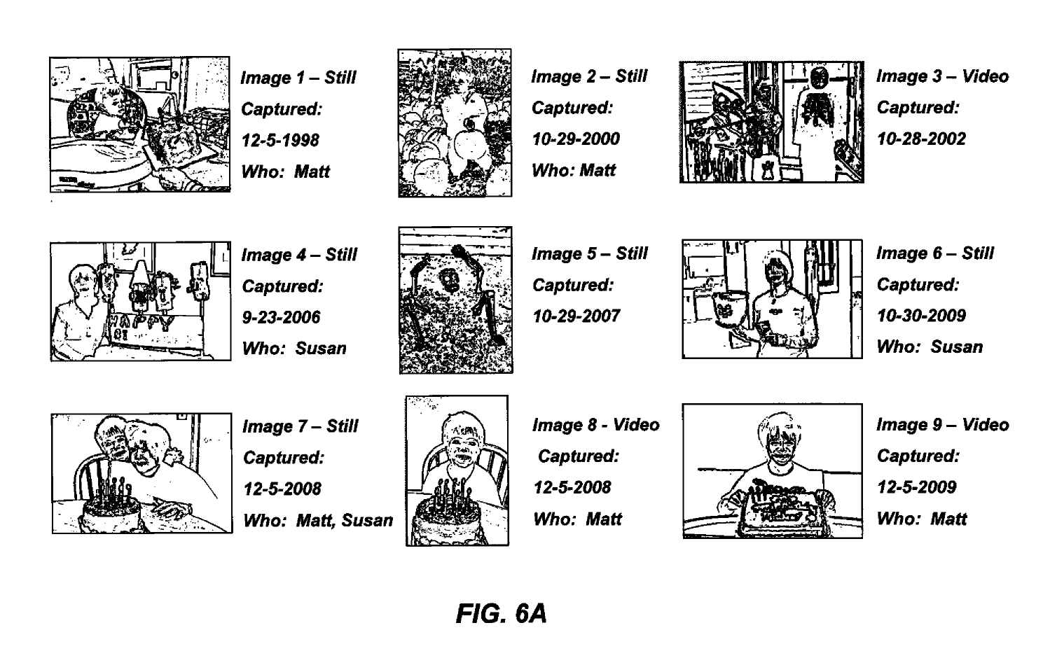

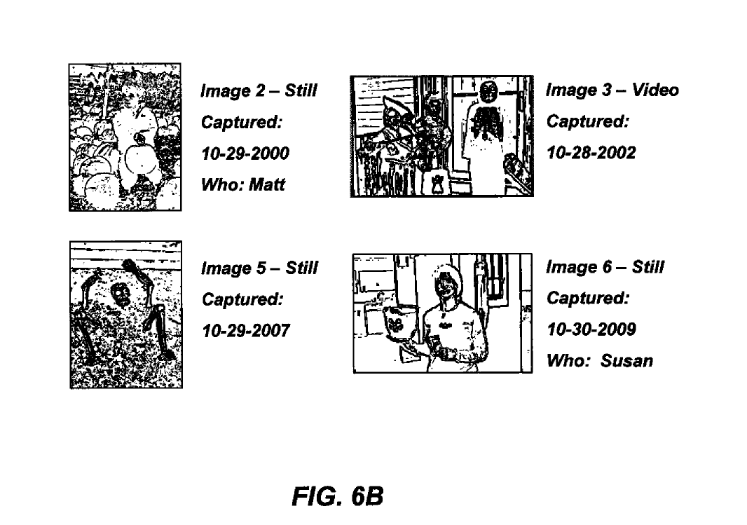

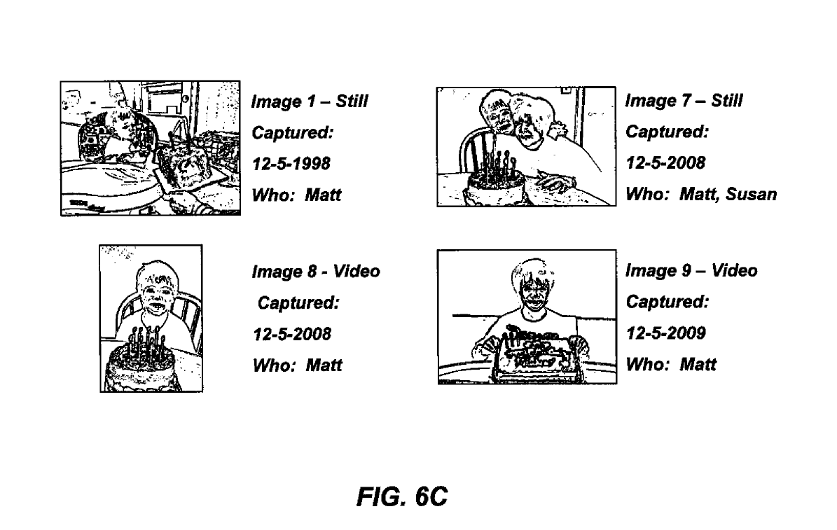

In identify associated digital images step 315, the central processor 20 identifies digital images and other digital media assets associated with the determined date. These identified digital images can include images that were captured on a day of the year falling within the “capture range” for the particular event. In this way, a digital image captured on a specific date will be associated with corresponding dates having the same month and day of the month in future years. For example, the digital still images and digital video clips that are displayed on the digital image display device 10 during the Halloween display date range can include not only Halloween images captured during the current calendar year, but also Halloween images captured in past calendar years. This can be accomplished as will be described later in reference to FIG. 6A-6C.

For holiday events that do not occur on the same date each year, digital images captured during a particular holiday season can be associated with ranges of dates corresponding to the particular holiday season in future years. For example, for a Thanksgiving event, digital images and other digital media assets associated with the date of Thanksgiving in each previous calendar year can be identified and preferentially displayed during the Thanksgiving display date range in the current calendar year. For example, if the current date is Nov. 24, 2010, this date falls within the Thanksgiving display date range (Nov. 25, 2010+/−1 week). Digital images associated with this date range would include those captured on Thanksgiving Day in previous years (i.e., Nov. 26, 2009; Nov. 27, 2008; Nov. 22, 2007, etc.).

In preferentially display identified digital images step 320, the central processor 20 preferentially displays the identified digital images and other digital media assets associated with the determined date on the display screen 40. Preferentially displaying means, for example, that the identified images are displayed more frequently than images that are not associated with the determined date. For example, during the Halloween period, instead of displaying all of the images stored in the collection of digital media assets with an equal probability, only the images captured (or shared) in the last few days are displayed, together with the images that were captured during the Halloween event capture range during previous calendar years. This provides timely content to be displayed, including images of Halloween costumes and parties captured in past years.

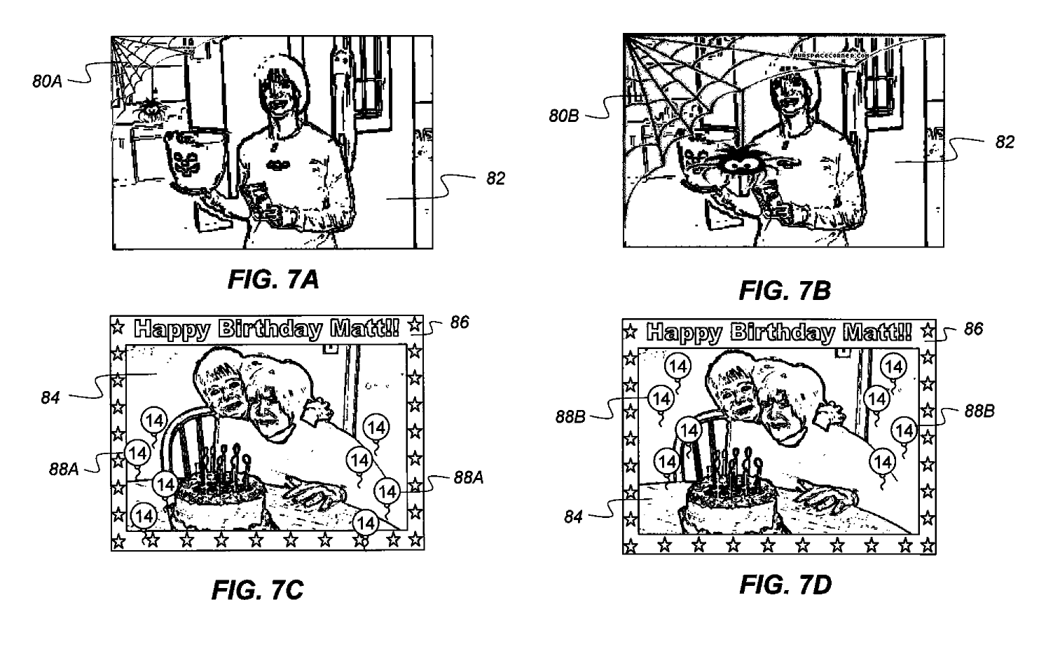

In an optional display additional content step 325, the central processor 20 displays additional content on the display screen 40 responsive to the determined date. This can be accomplished as will be described later in reference to FIG. 7A-7B.

FIG. 6A depicts nine particular digital images, and some of the associated metadata, from a collection of digital media assets stored in the non-volatile storage block 22 of the digital image display device 10. The images include three digital video clips and six still images. It will be understood that the non-volatile storage block 22 will typically store a much larger number of digital images and digital video clips, for example several hundred or several thousand images. Each of the digital images includes a capture date, which can be provided, for example, by the date/time metadata stored in the well-known Exif-JPEG image format when the digital image was captured by a digital camera. Many of the digital images also include metadata indicating the names of people in the images. This metadata can be provided either manually by the user, or using a face recognition algorithm.

FIG. 6B depicts four images, from the collection of nine images shown in FIG. 6A, which would be preferentially displayed when the current date falls within the Halloween event display date range from Table 1 (i.e., from October 15-November 5). These four images are identified to be preferentially displayed because their associated capture dates fall within the specified Halloween event capture date range (i.e., October 24-31). It will be understood that in some embodiments a user interface can be provided to enable the user to manually override this automatic determination, and select one or more of the images in FIG. 6B which should not be preferentially displayed even though the capture date is within capture range of dates for the Halloween event. Furthermore, the user could also manually override this automatic determination, and select one or more of the images in FIG. 6A which should be preferentially displayed during the Halloween event, even though the image capture date is outside the capture range of dates for the Halloween event.

FIG. 6C depicts four other images from the collection of nine images shown in FIG. 6A, which would be preferentially displayed during the display date range associated with the Matthew's Birthday event in Table 1 (i.e., from December 2-7). These four images will be preferentially displayed because their associated capture dates are within the capture date range associated with the Matthew's Birthday event (i.e., from December 5-6). In some embodiments, additional criteria can be specified to associate images with a particular event. For example, any images that contain a particular person can be associated with that person's Birthday event even if they have capture dates outside of the Birthday event capture date range. Similarly, any images that contain both the husband and the wife can be associated with the couple's Wedding Anniversary event, even if they have capture dates outside of the Wedding Anniversary event capture date range.

FIGS. 7A and 7B depict animated graphics overlaying a displayed image 82 at two slightly different moments in time, to better portray the animation. In this example, an animated spider web grows from a small size spider web graphic 80A in FIG. 7A to a large size spider web graphic 80B in FIG. 7B, as it crawls over the displayed image 82. This animation is in conjunction with the Halloween event listed in Table 1. The particular displayed image 82 is one of the images associated with the Halloween event because it has a capture date falling within the Halloween event capture date range listed in Table 1. It will be understood that various animated graphics can be used in addition to what is depicted in FIGS. 7A-7B, either on the same day, or on different days during the first range of dates.

FIGS. 7C-7D depicts a background template and animated graphics overlaying a displayed image 84 at two slightly different moments in time, to better portray the animation. In this example, a birthday related background template 86, associated with the second range of dates, surrounds the displayed image 84. In addition, the central processor 20 can play an audio or music file, which includes a birthday song or birthday greeting, as the graphic is displayed. A group of animated balloons rises up from a lower position 88A in FIG. 7C to an upper position 88B in FIG. 7D, as the balloons move upward in front of the displayed image 84.

The displayed content can optionally include information customized to the particular event. For example, in FIGS. 7C-7D, the balloons are labeled with a number “14” corresponding to an age calculated using the current year and the birth year listed in Table 1. Likewise, the background template 86 is labeled with the text “Happy Birthday Matt” to reflect the name of the person whose birthday is being celebrated. In some embodiments, the customized content is determined by the central processor 20, which calculates the age and generate the appropriate text message. In other embodiments, this can be done by the content and configuration server 110, which calculates the age and provides a corresponding text message to the digital image display device 10. The range of dates during which this particular birthday animation is used can include the entire display range listed in Table 1, or can be limited to a shorter period, such as the event date (e.g. the actual birthday, December 5) listed in Table 1.

In FIGS. 7C-7D, the displayed image 84 is one of the images associated with the Matthew's Birthday event listed in Table 1, the capture date for the image falling within the associated capture date range. In this example, this particular image is preferentially displayed because it is used in association with a background template and animated graphics associated with birthday events. It will be understood that various background templates and animated graphics can be used, in place of or in addition to what is depicted in FIG. 7C-7D, either on the same day, or on different days during the display range of dates associated with this birthday event. The background templates can include event specific templates for “collage” images, which can be used to simultaneously display a plurality of the images shown in FIG. 6C, during the display date range for the Matthew's Birthday” event.

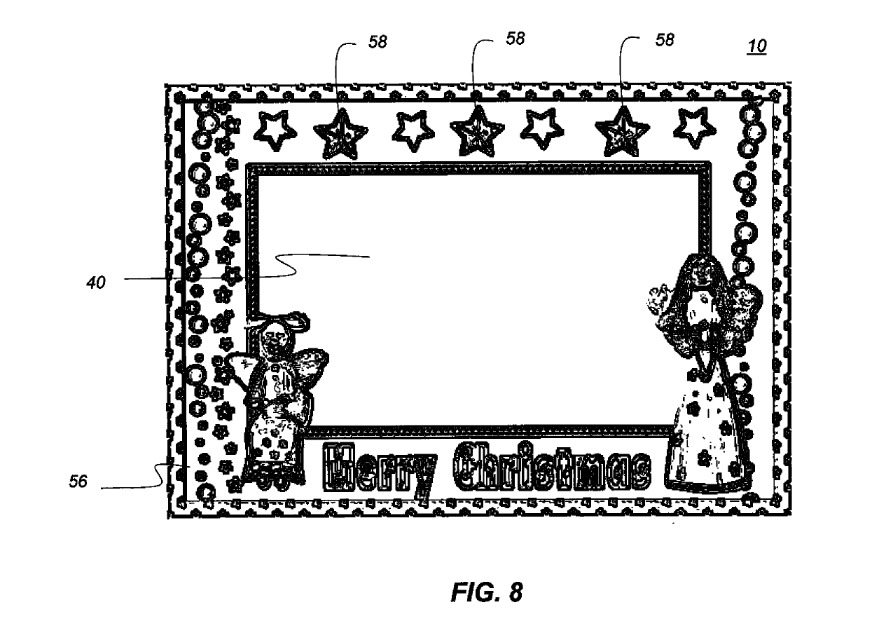

FIG. 8 depicts a decorative frame surround 56 which can be attached to the digital image display device 10. The decorative frame surround 56 can replace the standard frame surround 52 shown in FIGS. 2A-2B, by moving the sliders 54 show in FIG. 2B. Different decorative frame surrounds 56 can be used for some of the events listed in Table 1, so that the outer appearance of the digital image display device 10 can also be customized for the particular event.

The decorative frame surround 56 can include a number of light emitting elements, such as light emitting LED stars 58, and an electrical connector (not shown) to enable the light emitting elements to be powered by the power supply 50 and controlled by the central processor 20. In some embodiments, the light emitting elements can be controlled by the central processor 20 so that they light or blink in synchronization with the image transitions, or in synchronization with the appearance and movement of overlay animations.

In some embodiments, the decorative frame surround 56 can include circuitry that can provide a signal over the electrical connector (not shown) which identifies the type of event it is intended to be used with (e.g. Christmas, Halloween, etc.). In such an embodiment, the central processor 20 can use this signal, instead of the date range listed in Table 1, to determine the type of content that should be preferentially displayed on the display screen 40.

It will be understood that the digital images and additional content can be provided to the digital image display device 10 using systems other that the one depicted in FIG. 3. For example, a personal computer can be used to select events and additional content from a software program supplied with the digital image display device 10, or from service providers accessible to the personal computer via the Internet. The selected event information and additional content can then be stored on a removable storage device, such as a SD memory card or a USB jump drive. The removable storage device can then be removed from the personal computer and connected to the media interface block 32 of the digital image display device 10. The event information and additional content can be transferred, under the control of central processor 20, from the removable storage device to the non-volatile storage block 22.

In some embodiments, the determine date step 310 (FIG. 5) can determine a time from the real time clock 21 (FIG. 1) in addition to the date, and subsequent steps can use both the determined date and the time to identify and display appropriate digital images and additional content. For example, digital images that have capture times near midnight on New Year's Eve in previous years can be preferentially displayed at display times near midnight when the current time and date is near midnight on New Year's Eve in the current year. Similarly, additional content such as a “Happy New Year” message can be displayed together with the images.

As another example of using both the date and the time of day to identify and display appropriate digital images and additional content, the date can be used to determine sunrise and sunset times, and the time of day with respect to sunrise and sunset is used to select digital media assets and appropriate additional content. For example, sunrise images can be preferentially displayed when the time of day is near sunrise, sunset images can be preferentially displayed when the time of day is near sunset, and night-time images (e.g., images of the night sky or the moon) can be preferentially displayed after sunset and before sunrise. Optionally, appropriate messages can be selected and displayed with the digital media assets, such as “Rise and Shine!” at sunrise. To determine sunrise and sunset times, the geographic latitude is required and may be determined several different ways. For example, the latitude may be assumed based on the market into which the digital image display device is sold (e.g., North America or Australia), it can be provided by a user input, it can be inferred using the IP address of the digital image display device, it can be determined using a global positioning system receiver in the digital image display device 10, or it can be determined by WiFi geolocation.

In some embodiments, the time of day can be used without the date to identify and display appropriate digital media assets and additional content. For example, images captured in the morning may be displayed in the morning, images captured in the afternoon may be displayed in the afternoon, and images captured in the evening may be displayed in the evening. Alternatively, images with generally cool colors (e.g., blues and greens) can be displayed during the daytime, and images with generally warm colors (e.g., reds and yellows) can be displayed in the evening and at night.

Additional criteria can also be used to identify display digital media assets and additional content. For example, the current weather may be determined by querying an Internet-based weather service (using the geolocation of the digital image display device 10 which is determined, for example, in ways previously described). Images can then be selected for display based on the current weather. For example, if the weather is determined to be snowy and overcast, images of snowy landscapes, images of warm interiors, or images of summer beach scenes may be selected and displayed, depending on the user's preference. As another example, the current financial market status may be determined by querying an Internet-based service and digital media assets selected for display based on whether the market indicators are going up (selecting images of growing plants and birds, for example) or going down (selecting images of waterfalls and autumn leaves, for example).

Yet another exemplary criterion for identifying and displaying appropriate digital media assets and additional content is an individual's mood. The mood of an individual (either the owner or user of the digital image display device 10 or some other selected individual) may be input directly by the user, or it can determined by an appropriate query to the individual's social network web page (for example, the individual's Facebook page). Then digital media assets can be selected and displayed that have a general color that reflects the individual's mood. If the individual's mood is “angry,” then images that are generally red can be displayed; if the individual's mood is “glum,” then images that are generally blue can be displayed; and if the individual's mood is “happy,” then images that are generally yellow may be displayed. Alternatively, in the case of an individual's mood being “angry” or “glum,” images may be selected and displayed that are intended to provide an uplifting effect on the individual's mood (e.g., images that have a generally yellow color or images of puppies, kittens, and bunnies).

In the cases of using the current weather or an individual's current mood to select and display images, some digital media assets can be selected in which the selected images reflects the current weather or mood, and some can be selected that are contrary or opposed to the current weather or mood. In general, images may be selected and displayed that reflect a given criterion or that are contrary or opposed to a given criterion. Whether to select images that reflect or are contrary to a criterion can be predetermined, or can be determined by a user operable setting.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

A computer program product can include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to certain preferred embodiments thereof, but it will be understood that variations and modifications can be effected within the spirit and scope of the invention.

### PARTS LIST

10 digital image display device
20 central processor
21 real-time clock
22 non-volatile storage block
24 buffer memory block
34 buffer memory block
30 user input interfaces block
31 user buttons
32 media interface block
33 interface connectors
34 network interface block
40 display screen
42 display compensation block
44 speaker(s)
46 audio codec block
50 power supply
52 frame surround
54 sliders
56 decorative frame surround
58 LED star
80A small size spider web graphic
80B small size spider web graphic
82 displayed image
84 displayed image
86 background template
88A lower position
88B upper position
102 routing server
104 action logging server
106 authentication server
110 content and configuration server
120 web page server
122 administration configuration interface
124 web pages user interface
130 digital image and metadata content
140 E-mail server
150 content providing systems
152 external content media server
154 external content host
156 external digital image and metadata content
200 obtain list of digital media assets step
205 read next digital media asset step
210 decompress data step
215 resize image for display step
220 compensate image data for display step
225 display image step
230 respond to user interface inputs step
235 wait to display next digital media asset step
250 identify server(s) step
255 obtain security code token step
260 obtain and store new content step
265 obtain configuration information step
300 select events of interest step
305 provide additional content step
310 determine date step
315 identify associated digital images step
320 preferentially display identified digital images step
325 display additional content step

1. A digital image display device for displaying a collection of digital media assets, comprising:
a display screen;
a processor;
a real-time clock providing a date and time;
an interface for accessing a collection of digital media assets stored on a processor-accessible asset memory, wherein at least some of the digital media assets are associated with one or more specified ranges of dates; and
a processor-accessible program memory storing executable instructions for causing the processor to execute the steps of:
determining a date from the real-time clock;
identifying one or more digital media assets associated with a range of dates including the determined date; and
preferentially displaying the identified one or more digital media assets on the display screen.

2. The digital image display device of claim 1 wherein other digital media assets from the collection of digital media assets that are not associated with a range of dates including the determined date are also displayed on the display screen.

3. The digital image display device of claim 1 further including displaying additional content on the display screen responsive to the determined date.

4. The digital image display device of claim 3 wherein the additional content is a background template.

5. The digital image display device of claim 3 wherein the additional content is an overlay.

6. The digital image display device of claim 5 wherein the overlay is animated.

7. The digital image display device of claim 5 wherein the overlay is a text message.

8. The digital image display device of claim 1 further including a speaker and wherein an audio signal is played on the speaker responsive to the determined date.

9. The digital image display device of claim 1 wherein the processor-accessible asset memory is on a separate asset storage device.

10. The digital image display device of claim 8 wherein the interface used to access the separate asset storage device is a wireless interface or a wired interface.

11. The digital image display device of claim 1 wherein the processor-accessible asset memory is on a remote asset storage device, and wherein the interface is a network interface which is used to access the remote asset storage device.

12. The digital image display device of claim 1 wherein the processor-accessible asset memory is a removable media device.

13. The digital image display device of claim 1 wherein the specified ranges of dates are supplied by a user.

14. The digital image display device of claim 1 wherein the specified ranges of dates are determined using information from a calendar application or an social networking website.

15. The digital image display device of claim 1 wherein the specified ranges of dates include seasons, holidays, special events relevant to an individual, or dates corresponding to historical events.

16. The digital image display device of claim 15 wherein the special events relevant to an individual include a birthday or an anniversary.

17. The digital image display device of claim 16 wherein digital media assets containing the individual are associated with birthdays or anniversaries for the individual.

18. The digital image display device of claim 1 wherein digital media assets captured on a specific date are associated with corresponding dates having a same month and day of the month in future years.

19. The digital image display device of claim 1 wherein digital media assets captured during a particular holiday season are associated with ranges of dates corresponding to the particular holiday season in future years.

20. The digital image display device of claim 1 further including determining a time from the real time clock, and wherein content displayed on the display screen is further responsive to the determined time.

21. The digital image display device of claim 1 wherein the digital media assets are digital still images or digital video images.

22. A computer program product for controlling the display of a collection of digital media assets on a digital image display device including a display screen, the computer program product comprising a non-transitory tangible computer readable storage medium storing an executable software application for causing a data processing system to perform the steps of:
determining a date from a real-time clock;
identifying one or more digital media assets in the collection of digital media assets associated with a range of dates including the determined date; and
preferentially displaying the identified one or more digital media assets on the display screen.
